(19) United States
(12) Patent Application Publication
(10) Pub. No.: US 2026/0147595 A1
(43) Pub. Date: May 28, 2026

(54) SYSTEM AND METHOD FOR MANAGING PERIPHERALS IN A MULTI-CLOUD, MULTI-PROTOCOL, MULTI-DESKTOP ENVIRONMENT

(71) Applicant: JPMorgan Chase Bank, N.A., New York, NY (US)

(72) Inventors: Suresh THANKAPPAN, Shrewsbury, MA (US); Michael WILDE, Newark, DE (US); Jon MAEHLER, Westerville, OH (US); Julio CASTILLO, Sunnyside, NY (US); Raj RAMRUP, Queens Village, NY (US)

(73) Assignee: JPMorgan Chase Bank, N.A., New York, NY (US)

(21) Appl. No.: 19/394,467

(22) Filed: Nov. 19, 2025

Related U.S. Application Data
(60) Provisional application No. 63/725,743, filed on Nov. 27, 2024.

(51) Int. Cl. G06F 9/451; G06F 9/54; G06F 13/10

(52) U.S. Cl. CPC G06F 9/452; G06F 9/546; G06F 13/102; G06F 13/107

(57) ABSTRACT

Various methods and processes, apparatuses/systems, and media control peripheral devices in a multi-cloud, multi-desktop environment. A processor creates a synchronization agent that runs on a corresponding terminal of vendor specific remote desktops and act as a coordinator for managing one or more remote desktop applications running on different virtual desktop interface sessions that use different protocol specific to the corresponding vendor specific remote desktops. The synchronization agent receives device control commands from the one or more desktop applications and send them through virtual channels provided by the vendors the order in which it is received. Synchronization agent also sends command response back to the appropriate application from where it received a particular command. The synchronization agent ensures that overlapping and/or same family of commands are not sent over the virtual channels thereby substantially improving user experience and network performance, and protecting the peripheral devices from potential damage.

### CROSS-REFERENCE TO RELATED APPLICATIONS

This application claims the benefit of priority from U.S. provisional Patent Application No. 63/725,743, filed Nov. 27, 2024, which is herein incorporated by reference in its entirety.

### TECHNICAL FIELD

This disclosure generally relates to cloud computing, and, more particularly, to methods and apparatuses for implementing a domain, platform, language, cloud, protocol and database agnostic peripherals managing module configured for managing peripherals in a multi-cloud, multi-protocol, multi-desktop environment.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

There may be situations where an employee or an end user is provisioned with or subscribed to more than one cloud hosted virtual desktop due to business and/or functional requirements. When desktops are streamed to end user terminal, managing peripheral devices attached to the terminal such as camera, headphones, printers, scanners, etc., may prove to be difficult to manage from the desktop, especially when these peripheral devices are of different platforms. It may become crucial to synchronize the communication and controls across multi-cloud, multi-protocol, multi-desktop environment in such a way that applications running on different virtual desktop infrastructure (VDI) sessions may function smoothly without interfering with each other. Otherwise, any changes to configurations such as volume settings, firmware updates, camera controls, etc., may cause poor user experience, poor network performance, and potential damage to the peripheral devices.

For example, in conventional distributed computing systems that use networks, especially those that use multi-desktop or multi-cloud environments, multicast communications between applications and services implemented in software, as opposed to internetworking elements like routers and switches, often is needed. Currently, such one-to-many communication is implemented, if at all, at the application layer. Application programs and/or services are programmed to send repeated unicast application messages from a single source to multiple different recipients. This approach is highly inefficient with respect to use of network resources and bandwidth. Moreover, due to the necessity of application layer implementation, these conventional distributed computing systems lack configurations for synchronizing the communication and controls across the multi-cloud, multi-protocol, multi-desktop environments in such a way that applications running on different VDI sessions may function smoothly without interfering with each other, thereby causing poor user experience and poor network performance, and subjecting the peripheral devices for potential damage.

### SUMMARY

The present disclosure, through one or more of its various aspects, embodiments, and/or specific features or sub-components, provides, among other features, various systems, servers, devices, methods, media, programs, and platforms for implementing a domain, platform, language, cloud, and database agnostic peripherals managing module configured for managing peripheral devices, e.g., camera, headphones, printers, monitors, network ports, scanners, etc., in a multi-cloud, multi-protocol, multi-desktop network environment by synchronizing the communication and controls across the multi-cloud, multi-protocol, multi desktop network environment in such a way that applications running on different VDI sessions may function smoothly without interfering with each other, thereby substantially improving user experience and network performance, and protecting the peripheral devices from potential damage, but the disclosure is not limited thereto.

In some embodiments, a method for controlling a peripheral device among a plurality of peripheral devices in a multi-cloud, multi-desktop environment by utilizing one or more processors along with allocated memory is disclosed. The method may include: establishing a communication link among a remote terminal running on a remote desktop of a user and one or more remote desktop applications corresponding to the plurality of peripheral devices running on vendor specific other remote desktops via a communication network thereby creating a multi-cloud, multi-desktop environment; creating a synchronization agent via a corresponding application programming interface for each of the vendor specific other remote desktops, wherein the synchronization agent is configured to run on a corresponding terminal of the vendor specific other remote desktops and act as a coordinator for managing the one or more remote desktop applications running on different virtual desktop interface sessions that use different protocol specific to the corresponding vendor specific other remote desktops; receiving, by the synchronization agent executed by the one or more processors, commands from the one or more remote desktop applications to control a peripheral device running on each virtual desktop interface session; transmitting, by the synchronization agent executed by the one or more processors, each command to a remote driver running on the remote terminal via a corresponding vendor specific virtual channel in an order in which each command is received; generating a queue for executing each command based on determining, by the synchronization agent executed by the one or more processors, which remote desktop among the vendor specific other remote desktops the user is currently active on, and which command should take precedence based on a type of the peripheral device; and controlling, by the synchronization agent executed by the one or more processors, the peripheral device by executing the queue based on the type of the peripheral device within the multi-cloud, multi-desktop environment thereby improving execution performance of the one or more processors.

In some embodiments according to the method, the one or more peripheral devices may be physically connected to the remote terminal, and the method may further include: creating, by the synchronization agent executed by the one or more processors, one or more virtual peripheral devices that point to corresponding same one or more peripheral devices physically connected to the remote terminal; and assigning, by the synchronization agent executed by the one or more processors, the one or more virtual peripheral devices individually to the vendor specific other remote desktops in a manner such that the user sees the one or more virtual peripheral devices on each remote desktop session as individual device assigned to that specific desktop among the vendor specific other remote desktops.

In some embodiments according to the method, the one or more peripheral devices may include one or more of the following peripheral devices: a printer, a camera, a microphone, a monitor, a speaker, a wireless network connection port, etc., but the disclosure is not limited thereto.

In some embodiments, the method may further include: virtually connecting the one or more virtual peripheral devices to the vendor specific other remote desktops via the communication network and a corresponding application programming interface.

In some embodiments according to the method, within the multi-cloud, multi-desktop environment, the remote terminal may be running on a private cloud and each of the one or more other remote desktops may be running on corresponding public cloud, but the disclosure is not limited thereto.

In some embodiments according to the method, within the multi-cloud, multi-desktop environment, the remote terminal may be running on a public cloud and each of the one or more other remote desktops may be running on corresponding private cloud, but the disclosure is not limited thereto.

In some embodiments, in controlling the peripheral device, the method may further include: transmitting, by the remote driver executed by the one or more processors, each command to a message queue manager running on the remote terminal; managing, by the message queue manager executed by the one or more processors, command execution priority for the queue based on pre-defined command sets; transmitting, by the message queue manager executed by the one or more processors, the pre-defined command sets to a task manager running on the remote terminal; and executing, by the task manager executed by the one or more processors, a task corresponding to controlling the peripheral device and transmitting a result of execution back to the massage queue manager.

In some embodiments, a system for controlling a peripheral device among a plurality of peripheral devices in a multi-cloud, multi-desktop environment is disclosed. The system may include: a processor; and a memory operatively connected to the processor via a communication network, the memory storing computer readable instructions, when executed, may cause the processor to: establish a communication link among a remote terminal running on a remote desktop of a user and one or more remote desktop applications corresponding to the plurality of peripheral devices running on vendor specific other remote desktops via the communication network thereby creating a multi-cloud, multi-desktop environment; create a synchronization agent via a corresponding application programming interface for each of the vendor specific other remote desktops, wherein the synchronization agent is configured to run on a corresponding terminal of the vendor specific other remote desktops and act as a coordinator for managing the one or more remote desktop applications running on different virtual desktop interface sessions that use different protocol specific to the corresponding vendor specific other remote desktops; receive, by utilizing the synchronization agent, commands from the one or more remote desktop applications to control a peripheral device running on each virtual desktop interface session; transmit, by utilizing the synchronization agent, each command to a remote driver running on the remote terminal via a corresponding vendor specific virtual channel in an order in which each command is received; generate a queue for executing each command based on determining, by utilizing the synchronization agent, which remote desktop among the vendor specific other remote desktops the user is currently active on, and which command should take precedence based on a type of the peripheral device; and control, by utilizing the synchronization agent, the peripheral device by executing the queue based on the type of the peripheral device within the multi-cloud, multi-desktop environment thereby improving execution performance of the processor.

In some embodiments according to the system, the one or more peripheral devices may be physically connected to the remote terminal, and the processor may be further configured to: create, by the synchronization agent executed by the processor, one or more virtual peripheral devices that point to corresponding same one or more peripheral devices physically connected to the remote terminal; and assign, by the synchronization agent executed by the processor, the one or more virtual peripheral devices individually to the vendor specific other remote desktops in a manner such that the user sees the one or more virtual peripheral devices on each remote desktop session as individual device assigned to that specific desktop among the vendor specific other remote desktops.

In some embodiments according to the system, the one or more peripheral devices may include one or more of the following peripheral devices: a printer, a camera, a microphone, a monitor, a speaker, a wireless network connection port, etc., but the disclosure is not limited thereto.

In some embodiments, the processor may be further configured to: virtually connect the one or more virtual peripheral devices to the vendor specific other remote desktops via the communication network and a corresponding application programming interface.

In some embodiments according to the system, within the multi-cloud, multi-desktop environment, the remote terminal may be running on a private cloud and each of the one or more other remote desktops may be running on corresponding public cloud, but the disclosure is not limited thereto.

In some embodiments according to the system, within the multi-cloud, multi-desktop environment, the remote terminal may be running on a public cloud and each of the one or more other remote desktops may be running on corresponding private cloud, but the disclosure is not limited thereto.

In some embodiments, in controlling the peripheral device, the processor may be further configured to: transmit, by utilizing the remote driver executed by the processor, each command to a message queue manager running on the remote terminal; manage, by utilizing the message queue manager executed by the processor, command execution priority for the queue based on pre-defined command sets; transmit, by utilizing the message queue manager executed by the processor, the pre-defined command sets to a task manager running on the remote terminal; and execute, by utilizing the task manager executed by the processor, a task corresponding to controlling the peripheral device and transmitting a result of execution back to the massage queue manager.

In some embodiments, a non-transitory computer readable medium configured to store instructions for controlling a peripheral device among a plurality of peripheral devices in a multi-cloud, multi-desktop environment is disclosed. The instructions, when executed, may cause a processor to perform the following: establishing a communication link among a remote terminal running on a remote desktop of a user and one or more remote desktop applications corresponding to the plurality of peripheral devices running on vendor specific other remote desktops via a communication network thereby creating a multi-cloud, multi-desktop environment; creating a synchronization agent via a corresponding application programming interface for each of the vendor specific other remote desktops, wherein the synchronization agent is configured to run on a corresponding terminal of the vendor specific other remote desktops and act as a coordinator for managing the one or more remote desktop applications running on different virtual desktop interface sessions that use different protocol specific to the corresponding vendor specific other remote desktops; receiving, by the synchronization agent, commands from the one or more remote desktop applications to control a peripheral device running on each virtual desktop interface session; transmitting, by the synchronization agent, each command to a remote driver running on the remote terminal via a corresponding vendor specific virtual channel in an order in which each command is received; generating a queue for executing each command based on determining, by the synchronization agent, which remote desktop among the vendor specific other remote desktops the user is currently active on, and which command should take precedence based on a type of the peripheral device; and controlling, by the synchronization agent, the peripheral device by executing the queue based on the type of the peripheral device within the multi-cloud, multi-desktop environment.

In some embodiments according to the non-transitory computer readable medium, the one or more peripheral devices may be physically connected to the remote terminal, and the instructions, when executed, may cause the processor to further perform the following: creating, by the synchronization agent executed by the processor, one or more virtual peripheral devices that point to corresponding same one or more peripheral devices physically connected to the remote terminal; and assigning, by the synchronization agent executed by the processor, the one or more virtual peripheral devices individually to the vendor specific other remote desktops in a manner such that the user sees the one or more virtual peripheral devices on each remote desktop session as individual device assigned to that specific desktop among the vendor specific other remote desktops.

In some embodiments according to the non-transitory computer readable medium, the one or more peripheral devices may include one or more of the following peripheral devices: a printer, a camera, a microphone, a monitor, a speaker, a wireless network connection port, etc., but the disclosure is not limited thereto.

In some embodiments according to the non-transitory computer readable medium, the instructions, when executed, may cause the processor to further perform the following: virtually connect the one or more virtual peripheral devices to the vendor specific other remote desktops via the communication network and a corresponding application programming interface.

In some embodiments according to the non-transitory computer readable medium, within the multi-cloud, multi-desktop environment, the remote terminal may be running on a private cloud and each of the one or more other remote desktops may be running on corresponding public cloud, but the disclosure is not limited thereto.

In some embodiments according to the non-transitory computer readable medium, within the multi-cloud, multi-desktop environment, the remote terminal may be running on a public cloud and each of the one or more other remote desktops may be running on corresponding private cloud, but the disclosure is not limited thereto.

In some embodiments according to the non-transitory computer readable medium, in controlling the peripheral device, the instructions, when executed, may cause the processor to further perform the following: transmitting, by the remote driver executed by the processor, each command to a message queue manager running on the remote terminal; managing, by the message queue manager executed by the processor, command execution priority for the queue based on pre-defined command sets; transmitting, by the message queue manager executed by the processor, the pre-defined command sets to a task manager running on the remote terminal; and executing, by the task manager executed by the processor, a task corresponding to controlling the peripheral device and transmitting a result of execution back to the massage queue manager.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic peripherals managing module configured for managing peripherals in a multi-cloud, multi-protocol, multi-desktop environment in accordance with an embodiment.

FIG. 2 illustrates a diagram of a network environment with a platform, language, database, and cloud agnostic peripherals managing device in accordance with an embodiment.

FIG. 3 illustrates a system diagram for implementing a platform, language, database, and cloud agnostic peripherals managing device having a platform, language, database, and cloud agnostic peripherals managing module in accordance with an embodiment.

FIG. 4 illustrates a system diagram for implementing a platform, language, database, and cloud agnostic peripherals managing module of FIG. 3 in accordance with an embodiment.

FIG. 5 illustrates an architecture diagram for managing peripherals in a multi-cloud, multi-protocol, multi-desktop environment as implemented by the platform, language, database, and cloud agnostic peripherals managing module of FIG. 4 in accordance with an embodiment.

FIG. 6 illustrates a flow chart of a process implemented by the platform, language, database, and cloud agnostic peripherals managing module of FIG. 4 for managing peripherals in a multi-cloud, multi-protocol, multi-desktop environment in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, there may be situations where an employee or an end user is provisioned with or subscribed to more than one cloud hosted virtual desktop due to business and/or functional requirements. When desktops are streamed to end user terminal, managing peripheral devices attached to the terminal such as camera, headphones, monitors, network ports, printers, scanners, etc., may prove to be difficult to manage from the desktop, especially when these peripheral devices are of different platforms. It may become crucial to synchronize the communication and controls across multi-cloud, multi-protocol, multi-desktop environment in such a way that applications running on different VDI sessions may function smoothly without interfering with each other. Otherwise, any changes to configurations such as volume settings, firmware updates, camera controls, etc., may cause poor user experience and poor network performance, and potential damage to the peripheral devices.

However, in conventional distributed computing systems that use networks, especially those that use multi-desktop or multi-cloud environments, multicast communications between applications and services implemented in software, as opposed to internetworking elements like routers and switches, often is needed. Currently, such one-to-many communication is implemented, if at all, at the application layer. Application programs and/or services are programmed to send repeated unicast application messages from a single source to multiple different recipients. This approach is highly inefficient with respect to use of network resources and bandwidth. Moreover, due to the necessity of application layer implementation, these conventional distributed computing systems lack configurations for synchronizing the communication and controls across the multi-cloud, multi-protocol, multi-desktop environments in such a way that applications running on different VDI sessions may function smoothly without interfering with each other, thereby causing poor user experience and poor network performance, as well as subjecting the peripheral devices for potential damage.

To address the above-noted technical problems associated with conventional distributed computing systems, the present disclosure, through one or more of its various aspects, embodiments, and/or specific features or sub-components, provides, among other features, various systems, servers, devices, methods, media, programs, and platforms for implementing a domain, platform, language, cloud, and database agnostic peripherals managing module configured for managing peripheral devices, e.g., camera, headphones, printers, monitors, network ports, scanners, etc., in a multi-cloud, multi-protocol, multi-desktop environment by synchronizing the communication and controls across the multi-cloud, multi-protocol, multi desktop environment in such a way that applications running on different VDI sessions may function smoothly without interfering with each other, thereby substantially improving user experience and network performance, and protecting the peripheral devices from potential damage, but the disclosure is not limited thereto.

For example, the peripherals managing module as disclosed herein may be configured to build a synchronization agent running on an end user terminal that may act as a coordinator between multiple sessions even if they use different protocols such as Citrix®, Microsoft®, VMWare®, etc. The synchronization agent built by the peripherals managing module may be configured to receive change controls from a service running on each remote session via a corresponding secure virtual channel respectively corresponding each protocol and manage a queue to be executed at an earliest possible time based on the type of service.

The synchronization agent, in some embodiments, then make an intelligent decision based on which remote desktop the user is currently active on and what commands should take precedence. For example, if there is a request for increasing or decreasing volume of a speaker and the command came from a currently focused session, that takes priority so that the user may experience a real-time feeling about the controls. If, however, the synchronization agent receives a firmware update request for one of the headset attached to the terminal from one of the sessions, initiated by the user, the synchronization agent may be configured to check for an active audio in any of the session currently running and postpone the request for a later stage and wait for the audio session to terminate, thereby substantially improving user experience and network performance, and protecting the peripheral devices from potential damage, but the disclosure is not limited thereto.

Moreover, the synchronization agent may be configured to create virtual devices that points to the same physical device and assign them individually to remote desktop so that the user see them on each remote desktop sessions as individual device assigned to that specific desktop. Service running on the remote desktop session have the ability to either poll for status messages from the terminal or subscribe to a message queue asynchronously from where the synchronization agent on the terminal publishes about a status change, but the disclosure is not limited thereto.

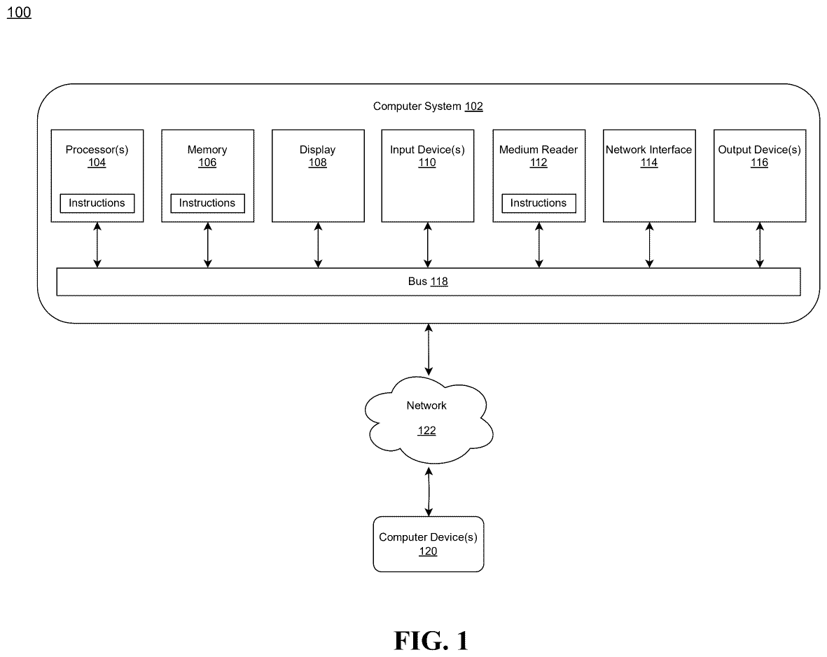

FIG. 1 is an exemplary system 100 for use in implementing a platform, language, database, and cloud agnostic peripherals managing module configured for managing peripherals in a multi-cloud, multi-protocol, multi-desktop environment in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the peripherals managing module may be platform, language, database, protocol, and cloud agnostic that may allow for consistent easy orchestration and passing of data through various components to output a desired result regardless of platform, browser, language, database, protocol, and cloud environment. Since the disclosed process, in some embodiments, may be platform, language, database, browser, and cloud agnostic, the peripherals managing module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

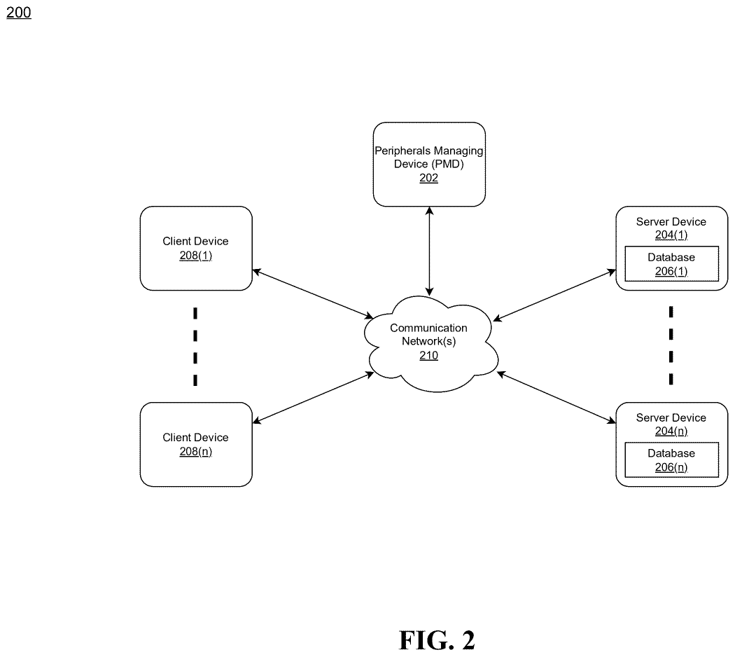

Referring to FIG. 2, a schematic of an exemplary network environment 200 for implementing a language, platform, database, and cloud agnostic peripherals managing device (PMD) of the instant disclosure is illustrated.

In some embodiments, the above-described problems associated with conventional tools may be overcome by implementing an PMD 202 as illustrated in FIG. 2 that may be configured for implementing a platform, language, database, and cloud agnostic peripherals managing module for managing peripheral devices, e.g., camera, headphones, printers, monitors, network ports, scanners, etc., in a multi-cloud, multi-protocol, multi-desktop network environment by synchronizing the communication and controls across the multi-cloud, multi-protocol, multi desktop network environment in such a way that applications running on different VDI sessions may function smoothly without interfering with each other, thereby substantially improving user experience and network performance, and protecting the peripheral devices from potential damage, but the disclosure is not limited thereto.

The PMD 202 may have one or more computer system 102s, as described with respect to FIG. 1, which in aggregate provide the necessary functions.

The PMD 202 may store one or more applications that may include executable instructions that, when executed by the PMD 202, cause the PMD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PMD 202 itself, may be located in virtual server(s) running in a cloud-based computing environment rather than being tied to one or more specific physical network computing devices. Also, the application(s) may be running in one or more virtual machines (VMs) executing on the PMD 202. Additionally, in one or more embodiments of this technology, virtual machine(s) running on the PMD 202 may be managed or supervised by a hypervisor.

In the network environment 200 of FIG. 2, the PMD 202 may be coupled to a plurality of server devices 204(1)-204(n) that hosts a plurality of databases 206(1)-206(n), and also to a plurality of client devices 208(1)-208(n) via communication network(s) 210. A communication interface of the PMD 202, such as the network interface 114 of the computer system 102 of FIG. 1, operatively couples and communicates between the PMD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PMD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The PMD 202 may be a standalone device or integrated with one or more other devices or apparatuses, such as one or more of the server devices 204(1)-204(n). In some embodiments, the PMD 202 may be hosted by one of the server devices 204(1)-204(n), and other arrangements may also be possible. Moreover, one or more of the devices of the PMD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the PMD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the PMD 202 that may efficiently provide a platform for implementing a platform, language, database, and cloud agnostic peripherals managing module configured for managing peripheral devices, e.g., camera, headphones, printers, monitors, network ports, scanners, etc., in a multi-cloud, multi-protocol, multi-desktop network environment by synchronizing the communication and controls across the multi-cloud, multi-protocol, multi desktop network environment in such a way that applications running on different VDI sessions may function smoothly without interfering with each other, thereby substantially improving user experience and network performance, and protecting the peripheral devices from potential damage, but the disclosure is not limited thereto.

The client devices 208(1)-208(n) may run interface applications, such as standard web browsers or standalone client applications, which may provide an interface to communicate with the PMD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the PMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the PMD 202, the server devices 204(1)-204(n), or the client devices 208(1)-208(n), in some embodiments, may be configured to operate as virtual instances on the same physical machine. In some embodiments, one or more of the PMD 202, the server devices 204(1)-204(n), or the client devices 208(1)-208(n) may operate on the same physical device rather than as separate devices communicating through communication network(s) 210. Additionally, there may be more or fewer PMDs 202, server devices 204(1)-204(n), or client devices 208(1)-208(n) than illustrated in FIG. 2. In some embodiments, the PMD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

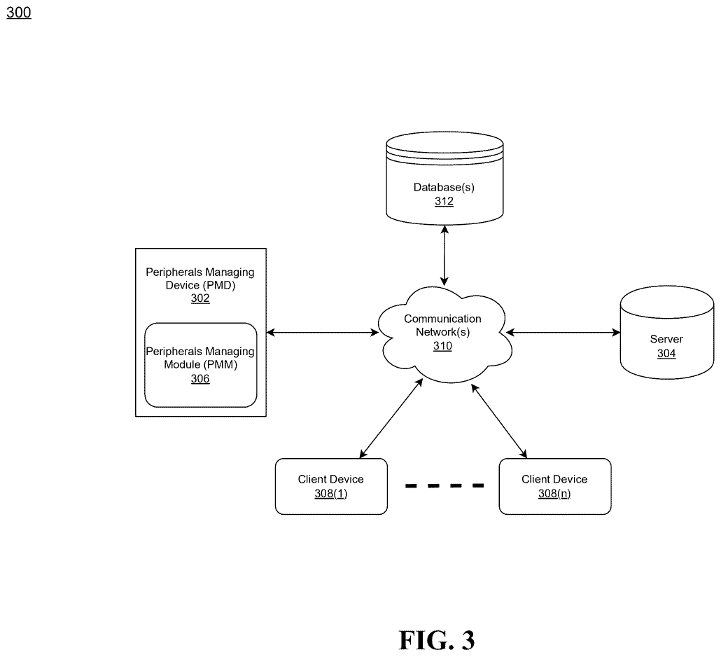

FIG. 3 illustrates a system diagram for implementing a platform, language, and cloud agnostic PMD having a platform, language, database, and cloud agnostic peripherals managing module (PMM) in accordance with an embodiment.

As illustrated in FIG. 3, the system 300 may include an PMD 302 within which an PMM 306 may be embedded, a server 304, a database(s) 312, a plurality of client devices 308(1) . . . 308(n), and a communication network 310.

In some embodiments, the PMD 302 including the PMM 306 may be connected to the server 304, and the database(s) 312 via the communication network 310. The PMD 302 may also be connected to the plurality of client devices 308(1) . . . 308(n) via the communication network 310, but the disclosure is not limited thereto.

According to exemplary embodiment, the PMD 302 is described and shown in FIG. 3 as including the PMM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the PMM 306 may be configured to receive real-time feed of data from the plurality of client devices 308(1) . . . 308(n) and secondary sources via the communication network 310.

As may be described below, the PMM 306 may be configured to: establish a communication link among a remote terminal running on a remote desktop of a user and one or more remote desktop applications corresponding to the plurality of peripheral devices running on vendor specific other remote desktops via the communication network thereby creating a multi-cloud, multi-desktop environment; create a synchronization agent via a corresponding application programming interface for each of the vendor specific other remote desktops, wherein the synchronization agent is configured to run on a corresponding terminal of the vendor specific other remote desktops and act as a coordinator for managing the one or more remote desktop applications running on different virtual desktop interface sessions that use different protocol specific to the corresponding vendor specific other remote desktops; receive, by utilizing the synchronization agent, commands from the one or more remote desktop applications to control a peripheral device running on each virtual desktop interface session; transmit, by utilizing the synchronization agent, each command to a remote driver running on the remote terminal via a corresponding vendor specific virtual channel in an order in which each command is received; generate a queue for executing each command based on determining, by utilizing the synchronization agent, which remote desktop among the vendor specific other remote desktops the user is currently active on, and which command should take precedence based on a type of the peripheral device; and control, by utilizing the synchronization agent, the peripheral device by executing the queue based on the type of the peripheral device within the multi-cloud, multi-desktop environment, but the disclosure is not limited thereto.

The plurality of client devices 308(1) . . . 308(n) are illustrated as being in communication with the PMD 302. In this regard, the plurality of client devices 308(1) . . . 308(n) may be “clients” (e.g., customers) of the PMD 302 and are described herein as such. Nevertheless, it is to be known and understood that the plurality of client devices 308(1) . . . 308(n) need not necessarily be “clients” of the PMD 302, or any entity described in association therewith herein. Any additional or alternative relationship may exist between either or both of the plurality of client devices 308(1) . . . 308(n) and the PMD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the PMD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The PMD 302 may be the same or similar to the PMD 202 as described with respect to FIG. 2, including any features or combination of features described with respect thereto.

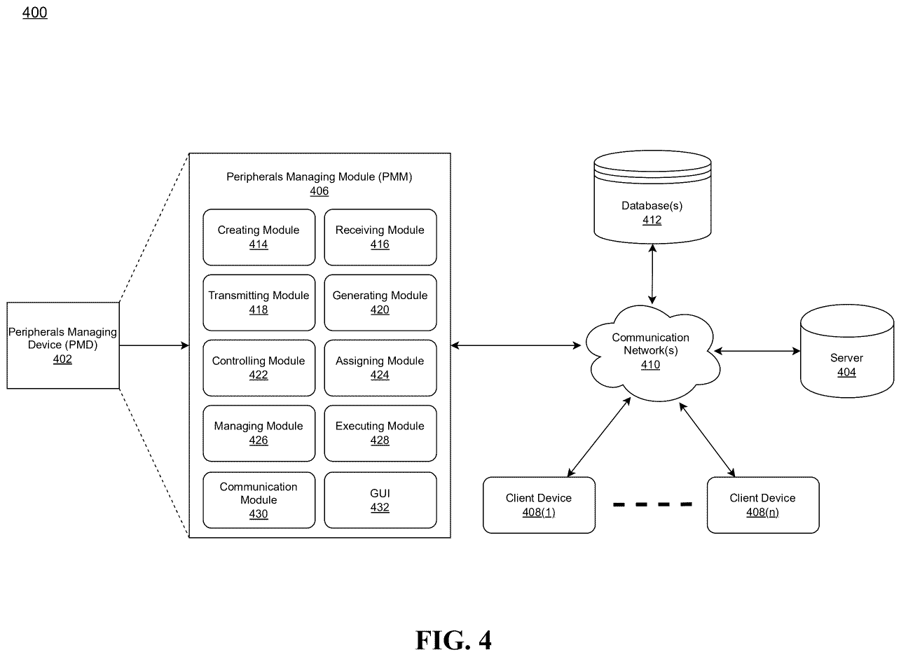

FIG. 4 illustrates a system diagram for implementing a platform, language, database, and cloud agnostic PMM of FIG. 3 in accordance with an exemplary embodiment.

In some embodiments, the system 400 may include a platform, language, database, and cloud agnostic PMD 402 within which a platform, language, database, protocol, and cloud agnostic PMM 406 may be embedded, a server 404, database(s) 412, and a communication network 410. In some embodiments, server 404 may comprise a plurality of servers located centrally or located in different locations, but the disclosure is not limited thereto.

In some embodiments, the PMD 402 including the PMM 406 may be connected to the server 404, and the database(s) 412 via the communication network 410. The PMD 402 may also be connected to the plurality of client devices 408(1)-408(n) via the communication network 410, but the disclosure is not limited thereto. The PMM 406, the server 404, the plurality of client devices 408(1)-408(n), the database(s) 412, the communication network 410 as illustrated in FIG. 4 may be the same or similar to the PMM 306, the server 304, the plurality of client devices 308(1)-308(n), the database(s) 312, the communication network 310, respectively, as illustrated in FIG. 3.

In some embodiments, as illustrated in FIG. 4, the PMM 406 may include creating module 414, a receiving module 416, a transmitting module 418, a generating module 420, a controlling module 422, an assigning module 424, a managing module 426, an executing module 428, a communication module 430, and a Graphical User Interface (GUI) 432. In some embodiments, interactions and data exchange among these modules included in the PMM 406 provide the advantageous effects of the disclosed invention. Functionalities of each module of FIG. 4 may be described in detail below with reference to FIGS. 4-6.

In some embodiments, each of the creating module 414, receiving module 416, transmitting module 418, generating module 420, controlling module 422, assigning module 424, managing module 426, executing module 428, and the communication module 430 of the PMM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the creating module 414, receiving module 416, transmitting module 418, generating module 420, controlling module 422, assigning module 424, managing module 426, executing module 428, and the communication module 430 of the PMM 406 of FIG. 4 may be implemented by microprocessors or similar, and may be programmed using software (e.g., microcode) to perform various functions discussed herein and may optionally be driven by firmware and/or software.

Alternatively, in some embodiments, each of the creating module 414, receiving module 416, transmitting module 418, generating module 420, controlling module 422, assigning module 424, managing module 426, executing module 428, and the communication module 430 of the PMM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the PMM 406 of FIG. 4 may also be implemented by cloud based deployment.

In some embodiments, each of the creating module 414, receiving module 416, transmitting module 418, generating module 420, controlling module 422, assigning module 424, managing module 426, executing module 428, and the communication module 430 of the PMM 406 of FIG. 4 may be called via corresponding API, but the disclosure is not limited thereto.

For example, the creating module 414 may be called via a first API, the receiving module 416 may be called via a second API, the transmitting module 418 may be called via a third API, the generating module 420 may be called via a fourth API, the controlling module 422 may be called via a fifth API, the assigning module 424 may be called via a sixth API, the managing module 426 may be called via a seventh API, the executing module 428 may be called via an eighth API, and the communication module 430 may be called via a ninth API. In some embodiments, calls may also be made using event based message interfaces in addition to APIs.

In some embodiments, the process implemented by the PMM 406 may be executed via the communication module 430, and the communication network 410, which may comprise plural networks as described above. In some embodiments, in an exemplary embodiment, the various components of the PMM 406 may communicate with the server 404, and the database(s) 412 via the communication module 430 and the communication network 410 and the results may be displayed onto the GUI 432. Of course, these embodiments are merely exemplary and are not limiting or exhaustive. The database(s) 412 may include the databases included within the private cloud and/or public cloud and the server 404 may include one or more servers within the private cloud and the public cloud.

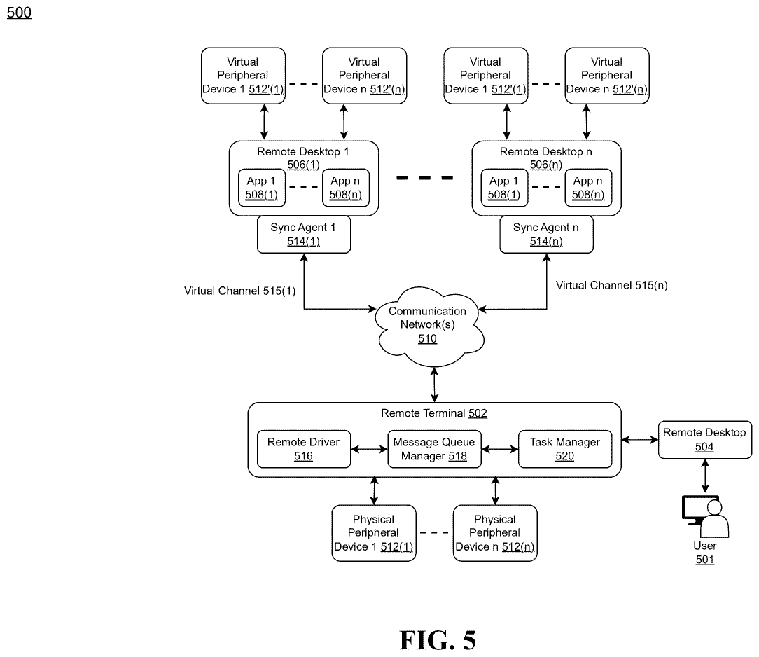

FIG. 5 illustrates an architecture diagram 500 for managing peripherals in a multi-cloud, multi-protocol, multi-desktop environment as implemented by the platform, language, database, protocol, and cloud agnostic PMM 406 of FIG. 4 in accordance with an embodiment. As illustrated in FIG. 5, a remote terminal 502 running within a remote desktop 504 of a user 501 may be operatively connected to one or more other remote desktops, i.e., remote desktop 1 506(1)-remote desktop n 506(n) via a communication network(s) 510. The communication network(s) 510 may be the same or similar to the communication network(s) 410 as illustrated with reference to FIG. 4. The remote terminal 502 may run on Windows®, Linux®, or Macintosh® operating systems, but the disclosure is not limited thereto. For example, the remote terminal 502 may run on any other compatible operating systems without departing from the scope of the present disclosure.

In some embodiments, the PMM 406 as disclosed herein may be configured to build a synchronization agent, i.e., synchronization agent 1 514(1)-synchronization agent 514(n) as illustrated in FIG. 5, running on an end user terminal that may act as a coordinator between multiple sessions even if they use different protocols such as Citrix®, Microsoft®, VMWare®, etc. The synchronization agent 514(1)-514(n) built by the PMM 406 may be configured to receive change controls from a service, i.e., increasing contrast of a monitor, decreasing volume of a microphone, updating firmware, etc., but the disclosure is not limited thereto, running on each remote session via a corresponding secure virtual channel respectively corresponding each protocol and manage a queue to be executed at an earliest possible time based on the type of service.

For example, referring back to FIGS. 4-5, one or more physical peripheral devices 512(1)-512(n) may be physically connected to the remote terminal 502. The physical peripheral devices may include a printer, a camera, a scanner, a microphone, a monitor, a speaker, a wireless network connection port, etc., but the disclosure is not limited thereto. For example, the physical peripheral devices may include any other peripheral devices without departing from the scope of the present disclosure. In some embodiments, physical connection may be achieved by utilizing know universal serail bus or other known methods without departing from the scope of the present disclosure.

In some embodiments, the creating module 414 as illustrated in FIG. 4 may be configured to create, by utilizing the synchronization agent 514(1)-514(n), one or more virtual peripheral devices 512′(1)-512′(n) that respectively point to corresponding same one or more physical peripheral devices 512(1)-512(n) physically connected to the remote terminal 502. Virtual connection of the one or more virtual peripheral devices 512′(1)-512′(n) to the vendor specific remote desktops 506(1)-506(n) may be achieved via the communication network and a corresponding API as mentioned above with respect to FIGS. 1-3.

The assigning module 424 as illustrated in FIG. 4 may be configured to assign, by utilizing the synchronization agent 514(1)-514(n), the one or more virtual peripheral devices 512′(1)-512′(n) individually to the vendor specific other remote desktops, i.e., remote desktop 1 506(1)-remote desktop n 506(n) in a manner such that the user 501 sees the one or more virtual peripheral devices 512′(1)-512′(n) on each remote desktop session as individual device assigned to that specific desktop among the vendor specific other remote desktops. As illustrated in FIG. 5, one or more applications 508(1)-508(n) running within each remote desktops 506(1)-506(n) may be configured to operatively control a service associated with each of the virtual peripheral devices 512′(1)-512′(n).

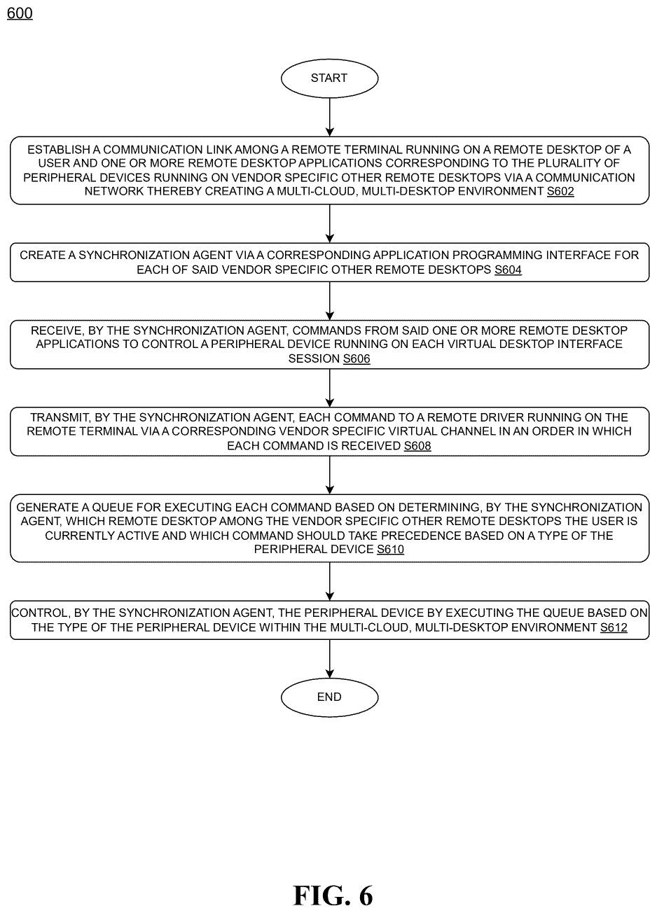

FIG. 6 illustrates a flow chart of a process 600 implemented by the platform, language, database, protocol, and cloud agnostic PMM 406 of FIG. 4 for managing peripherals, i.e., 512′(1)-512′(n), in a multi-cloud, multi-protocol, multi-desktop environment in accordance with an embodiment. It may be appreciated that the illustrated process 600 and associated steps may be performed in a different order, with illustrated steps omitted, with additional steps added, or with a combination of reordered, combined, omitted, or additional steps.

Referring back to FIGS. 4-6, as illustrated in FIG. 6, at step S602, the process 600 may include establishing, by utilizing the communication module 430 of FIG. 4, a communication link among a remote terminal 502 running on a remote desktop 504 of a user 501 and one or more remote desktop applications 508(1)-508(n) corresponding to the plurality of peripheral devices 512′(1)-512′(n) running on vendor specific other remote desktops 506(1)-506(n) via a communication network 410, 510, thereby creating a multi-cloud, multi-desktop environment.

At step S604, the process 600 may include creating, by utilizing the creating module 414 of FIG. 4, a synchronization agent 514(1)-514(n) via a corresponding application programming interface for each of the vendor specific other remote desktops 506(1)-506(n). The synchronization agent 514(1)-514(n) may be configured to run on a corresponding terminal of the vendor specific other remote desktops 506(1)-506(n) and act as a coordinator for managing the one or more remote desktop applications 508(1)-508(n) running on different VDI sessions that use different protocol specific to the corresponding vendor specific other remote desktops 506(1)-506(n). For example, each of the VDI sessions may use different protocols such as Citrix®, Microsoft®, VMWare®, etc., but the disclosure is not limited thereto to these particular protocols. The VDI sessions may use any other protocol without departing from the scope of the present disclosure.

At step S606, the process 600 may include receiving, by the synchronization agent 514(1)-514(n) by utilizing the receiving module 416, commands from the one or more remote desktop applications 508(1)-508(n) to control a peripheral device, i.e., 512′(1)-512′(n), running on each VDI session. As mentioned earlier, the peripheral device 512′(1)-512′(n) may include a printer, a camera, a microphone, a monitor, a speaker, scanner, a wireless network connection port, etc., but the disclosure is not limited thereto.

At step S608, the process 600 may include transmitting, by the synchronization agent 514(1)-514(n) by utilizing the transmitting module 418 of FIG. 4, each command to a remote driver 516 running on the remote terminal 502 via a corresponding vendor specific virtual channel, i.e., virtual channels 515(1)-515(n), in an order in which each command is received.

As illustrated in the architecture diagram 500 of FIG. 5, the virtual channels 515(1)-515(n) are also multi-protocol, i.e., a client may connect to a remote desktop via different protocol that is proprietary to a vendor. For example, when a client connects to the remote desktop 506(1) from Microsoft cloud, the client may connect to the remote desktop 506(1) using Remote Desktop Protocol (RDP) if the client is Windows® application or a terminal services client. If one of the client uses Citrix®, that client may connect to the remote desktop 506(1) via a Citrix® propitiatory virtual channel High Definition Experience (HDX). If one of the client uses VMWare®, that client may connect to the remote desktop 506(1) via VMWare® Blast or PC-over-IP (PCoIP) protocol, but the disclosure is not limited thereto. VMware® Blast and PCoIP are both remote display protocols used in VMware® horizon view to allow a user to access a desktop or application remotely.

All three vendors mentioned above (Microsoft®, Citrix® or VMWare®—the three most popular and widely used by enterprises) have client application that may run on Linux™, Windows®, MAC, iOS, Android®, etc., that may connect to a remote desktop windows session. In some embodiments, they may also connect to a Linux™ remote desktop. For example, a user may have a Citrix® client (Citrix® application for Linux™) in the office that connects to a remote Linux™ desktop and also to a remote Windows® desktop from the same terminal at the same time so that the user may switch between Linux™ and Windows® for work, but the disclosure is not limited thereto.

At step S610, the process 600 may include generating a queue for executing each command based on determining, by the synchronization agent 514(1)-514(n) by utilizing the generating module 420 of FIG. 4, which remote desktop among the vendor specific other remote desktops the user is currently active on, and which command should take precedence based on a type of the peripheral device. For example, if there is a request for increasing or decreasing volume of a speaker and the command came from a currently focused session, that takes priority so that the user 501 may experience a real-time feeling about the controls. If, however, the synchronization agent 514(1)-514(n) receives a firmware update request for one of the headset attached to the remote terminal 502 from one of the VDI sessions, initiated by the user 501, the synchronization agent 514(1)-514(n) may be configured to check, by utilizing the managing module 426 of FIG. 4, for an active audio in any of the session currently running and postpone the request for a later stage and wait for the audio session to terminate, thereby substantially improving user experience and network performance, and protecting the peripheral devices 512(1)-512(n), 512′(1)-512′(n) from potential damage, but the disclosure is not limited thereto.

Moreover, as mentioned earlier, the synchronization agent 514(1)-514(n) may be configured to create virtual devices that points to the same physical device and assign them individually to remote desktop so that the user see them on each remote desktop sessions as individual device assigned to that specific desktop. Thus, service running on the remote desktop session have the ability to either poll for status messages from the remote terminal 502 or subscribe to a message queue asynchronously from where the synchronization agent 514(1)-514(n) on the remote terminal 502 publishes about a status change, but the disclosure is not limited thereto.

In some embodiments, performance of the synchronization agent 514(1)-514(n) may be facilitated by implementing the remove driver 516, message queue manager 518, and the task manager 520 running on the remote terminal 502 as illustrated in FIG. 5.

For example, the synchronization agent 514(1)-514(n) may be further configured to resolve any conflict resolutions by implementing the remove driver 516, message queue manager 518, and the task manager 520 running on the remote terminal 502 case of receiving similar or conflicting commands over the virtual channel 515(1)-515(n). Consider a scenario where two or more applications 508(1)-508(n) are trying to adjust volume corresponding to a virtual peripheral device 512(1)-512(n). In such a scenario, the synchronization agent 514(1)-514(n) agent may inform the application owner about the command in progress status and lock the command until the previous execution is completed.

In the event of the synchronization agent 514(1)-514(n) receiving a conflicting command exactly at the same instance from applications 508(1)-508(n), the synchronization agent 514(1)-514(n) may randomly pick from one of the application, i.e., application 508(1), and inform the rest of the applications 508(2)-508(n) for awareness. In order to do that, the synchronization agent 514(1)-514(n) may utilize the remote driver 516, message queue manager 518 and the task manager 520 as illustrated in FIG. 5.

For example, the remote driver 516 may receive and may tag commands from the synchronization agents 514(1)-514(n) and may transmit the tagged commands to the message queue manager 518. The message queue manager 518 may receive the tagged commands from the remote driver 516 and may manage command execution priority based on pre-defined command sets and may transmit them to the task manager 520. For example, pre-defined command sets may include, in a scenario where two or more applications 508(1)-508(n) are trying to control a virtual peripheral device 512(1)-512(n), a command to inform the application owner about the command in progress status and lock the command until the previous execution is completed, but the disclosure is not limited thereto. The pre-defined command sets may also include, in a scenario where the synchronization agent 514(1)-514(n) receives a conflicting command exactly at the same instance from applications 508(1)-508(n), a command to randomly pick from one of the application, i.e., application 508(1), and inform the rest of the applications 508(2)-508(n) for awareness.

The task manger 520 may receive the pre-defined command sets from the message queue manger 518 and may execute, by utilizing the executing module 428 as illustrated in FIG. 4, low level task on client devices or operating system utilized by the user 501 such as adjust volumes, update firmware, change device settings, etc., but the disclosure is not limited thereto. The task manager 520 may transmit execution results to the message queue manager 518. The task manager 520 may be configured to validate commands before execution and ensure device security.

In some embodiments, a list of command that may be safely executed may be stored in an encrypted local storage, i.e., within the memory 106 as illustrated with respect to FIG. 1, and compared against the received remote command. The task manager 520 may be configured to only execute the command if there is a match between the received remote command and a command from the list. If the task manager 520 receives too many (configurable) failed comparisons, it may suspend further execution of any command and alert a central monitoring system for further action by a support team. Example, of a list of command may include {“getdevicelist”, “getfirmwareversion”, “setfrequency”, “enablepowersaving”, “updatefw”, “fwlocation”}, but the disclosure is not limited thereto.

The message queue manager 518 may be configured to receive command execution results asynchronously from the task manager and transmit the execution results to the remote driver based on priority. A sender does not have to wait for a previous command to finish before sending another command. These commands may be executed in an order or based on priority and returned back to the sender as the execution is completed. Examples may include of {“getdevicelist:4”, “setbrightness:1”, “setvolume:1”}, if the system receives these 3 commands, the execution priority is “setvolume’ and “setbrightness” has same priority. However, these commands may be executed simultaneously as they are applied on different devices and the response is send back based on which command finishes first. In some embodiments, where the commands are applied to the same device, a sequence has to be followed depending on the status of the device. For example, {“pairdevice:2”, “connectdevice:2”, “setvolume:1”}. In this example, even though the “setvolume” command has higher priority, it cannot be executed first if the device is NOT in a connected state, thereby changing the priority dynamically pairdevice→connectdevice→setvolume.

The remote driver 516 may be configured to receive response from the message queue and transmit to the appropriate synchronization agent 514(1)-514(n). The remote driver 516 may also be responsible for conflict management by ensuring overlapping and/or same family of commands coming from multiple remote desktops 506(1)-506(n) are not executed thereby maintaining application consistency across platform and informing appropriate synchronization agent 514(1)-514(n) of user intention (i.e., executing a firmware update from multiple remote desktops 506(1)-606(n)). The remote driver 516 may further be configured to assign, by utilizing the assigning module 424 as illustrated in FIG. 4, a master device from one of the remote desktops 506(1)-506(n) so that only one remote desktop may be able to send remote execution commands.

At step S612, the process 600 may include controlling, by the synchronization agent 514(1)-514(n) by utilizing the controlling module 422 as illustrated in FIG. 4, the peripheral device, i.e., any one of 512(1)-512(n), 512′(1)-512′(n), by executing the queue as received from the message queue manager 518 based on the type of the peripheral device within the multi-cloud, multi-desktop environment. The type of the peripheral device may correspond to specific service, i.e., print, volume increase/decrease, monitor's contrast increase/decrease, Bluetooth connection, etc., associated with corresponding peripheral devices 512(1)-512(n), 512′(1)-512′(n), but the disclosure is not limited thereto.

In controlling the peripheral device, i.e., any one of 512(1)-512(n), 512′(1)-512′(n), at step S612, the process 600 may further include transmitting, by the remote driver 516, each command to the message queue manager 518 running on the remote terminal 502; managing, by the message queue manager 518 by utilizing the managing module 426 as illustrated in FIG. 4, command execution priority for the queue based on pre-defined command sets. The pre-defined command sets may be the same or similar to the pre-defined command sets disclosed above with reference to step S610. In controlling the peripheral device, i.e., any one of 512(1)-512(n), 512′(1)-512′(n), at step S612, the process 600 may further include transmitting, by the message queue manager 518 by utilizing the transmitting module 418 as illustrated in FIG. 4, the pre-defined command sets to the task manager 520 running on the remote terminal 502; and executing, by the task manager 520 by utilizing the executing module 428 as illustrated in FIG. 4, a task corresponding to controlling the peripheral device, i.e., any one of 512(1)-512(n), 512′(1)-512′(n), and transmitting a result of execution back to the massage queue manager 518.

In some embodiments, the PMD 402 may include a memory (e.g., a memory 106 as illustrated in FIG. 1) which may be a non-transitory computer readable medium that may be configured to store instructions for implementing a platform, language, database, and cloud agnostic PMM 406 for managing and controlling peripheral devices, e.g., camera, headphones, printers, monitors, network ports, scanners, etc., in a multi-cloud, multi-protocol, multi-desktop network environment by synchronizing the communication and controls across the multi-cloud, multi-protocol, multi desktop network environment in such a way that applications running on different VDI sessions may function smoothly without interfering with each other, thereby substantially improving user experience and network performance, and protecting the peripheral devices from potential damage as described herein. The instructions, when executed by a processor embedded within the PMM 406 or within the PMD 402, may be used to perform one or more of the processes as described herein. In a particular embodiment, the instructions may reside completely, or at least partially, within the memory 106, the medium reader 112, and/or the processor 104 (see FIG. 1) during execution by the PMD 402.

In some embodiments, the instructions, when executed, may cause a processor embedded within the PMM 406 or the PMD 402 to perform the following: establishing a communication link among a remote terminal running on a remote desktop of a user and one or more remote desktop applications corresponding to the plurality of peripheral devices running on vendor specific other remote desktops via a communication network thereby creating a multi-cloud, multi-desktop environment; creating a synchronization agent via a corresponding application programming interface for each of the vendor specific other remote desktops, wherein the synchronization agent is configured to run on a corresponding terminal of the vendor specific other remote desktops and act as a coordinator for managing the one or more remote desktop applications running on different virtual desktop interface sessions that use different protocol specific to the corresponding vendor specific other remote desktops; receiving, by the synchronization agent, commands from the one or more remote desktop applications to control a peripheral device running on each virtual desktop interface session; transmitting, by the synchronization agent, each command to a remote driver running on the remote terminal via a corresponding vendor specific virtual channel in an order in which each command is received; generating a queue for executing each command based on determining, by the synchronization agent, which remote desktop among the vendor specific other remote desktops the user is currently active on, and which command should take precedence based on a type of the peripheral device; and controlling, by the synchronization agent, the peripheral device by executing the queue based on the type of the peripheral device within the multi-cloud, multi-desktop environment. In some embodiments, the processor may be the same or similar to the processor 104 as illustrated in FIG. 1 or the processor embedded within the PMD 202, PMD 302, PMD 402, and PMM 406 which may be the same or similar to the processor 104.

In some embodiments, the one or more peripheral devices may be physically connected to the remote terminal, and the instructions, when executed, may cause the processor 104 to further perform the following: creating, by the synchronization agent, one or more virtual peripheral devices that point to corresponding same one or more peripheral devices physically connected to the remote terminal; and assigning, by the synchronization agent, the one or more virtual peripheral devices individually to the vendor specific other remote desktops in a manner such that the user sees the one or more virtual peripheral devices on each remote desktop session as individual device assigned to that specific desktop among the vendor specific other remote desktops. In some embodiments, the one or more peripheral devices may include one or more of the following peripheral devices: a printer, a camera, a microphone, a monitor, a speaker, a wireless network connection port, etc., but the disclosure is not limited thereto.

In some embodiments, the instructions, when executed, may cause the processor 104 to further perform the following: virtually connecting the one or more virtual peripheral devices to the vendor specific other remote desktops via the communication network and a corresponding application programming interface. Within the multi-cloud, multi-desktop environment, the remote terminal may be running on a private cloud and each of the one or more other remote desktops may be running on corresponding public cloud, but the disclosure is not limited thereto. Within the multi-cloud, multi-desktop environment, the remote terminal may be running on a public cloud and each of the one or more other remote desktops may be running on corresponding private cloud, but the disclosure is not limited thereto.

In some embodiments, in controlling the peripheral device, the instructions, when executed, may cause the processor 104 to further perform the following: transmitting, by the remote driver, each command to a message queue manager running on the remote terminal; managing, by the message queue manager, command execution priority for the queue based on pre-defined command sets; transmitting, by the message queue manage, the pre-defined command sets to a task manager running on the remote terminal; and executing, by the task manager, a task corresponding to controlling the peripheral device and transmitting a result of execution back to the massage queue manager.

In some embodiments as disclosed above in FIGS. 1-6, technical improvements effected by the instant disclosure may include a platform for implementing a platform, language, database, and cloud agnostic peripherals managing module configured for managing peripheral devices, e.g., camera, headphones, printers, monitors, network ports, scanners, etc., in a multi-cloud, multi-protocol, multi-desktop network environment by synchronizing the communication and controls across the multi-cloud, multi-protocol, multi desktop network environment in such a way that applications running on different VDI sessions may function smoothly without interfering with each other, thereby substantially improving user experience and network performance, and protecting the peripheral devices from potential damage, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for controlling a peripheral device among a plurality of peripheral devices in a multi-cloud, multi-desktop environment by utilizing one or more processors along with allocated memory, the method comprising:
establishing a communication link among a remote terminal running on a remote desktop of a user and one or more remote desktop applications corresponding to the plurality of peripheral devices running on vendor specific other remote desktops via a communication network thereby creating a multi-cloud, multi-desktop environment;
creating a synchronization agent via a corresponding application programming interface for each of said vendor specific other remote desktops, wherein the synchronization agent is configured to run on a corresponding terminal of the vendor specific other remote desktops and act as a coordinator for managing the one or more remote desktop applications running on different virtual desktop interface sessions that use different protocol specific to the corresponding vendor specific other remote desktops;
receiving, by the synchronization agent executed by the one or more processors, commands from said one or more remote desktop applications to control a peripheral device running on each virtual desktop interface session;
transmitting, by the synchronization agent executed by the one or more processors, each command to a remote driver running on the remote terminal via a corresponding vendor specific virtual channel in an order in which each command is received;
generating a queue for executing each command based on determining, by the synchronization agent executed by the one or more processors, which remote desktop among the vendor specific other remote desktops the user is currently active on, and which command should take precedence based on a type of the peripheral device; and
controlling, by the synchronization agent executed by the one or more processors, the peripheral device by executing the queue based on the type of the peripheral device within the multi-cloud, multi-desktop environment.

2. The method according to claim 1, wherein said one or more peripheral devices are physically connected to the remote terminal, and the method further comprising:
creating, by the synchronization agent executed by the one or more processors, one or more virtual peripheral devices that point to corresponding same one or more peripheral devices physically connected to the remote terminal; and
assigning, by the synchronization agent executed by the one or more processors, the one or more virtual peripheral devices individually to the vendor specific other remote desktops in a manner such that the user sees the one or more virtual peripheral devices on each remote desktop session as individual device assigned to that specific desktop among the vendor specific other remote desktops.

3. The method according to claim 2, wherein the one or more peripheral devices include one or more of the following peripheral devices: a printer, a camera, a microphone, a monitor, a speaker, and a wireless network connection port.

4. The method according to claim 3, further comprising:
virtually connecting the one or more virtual peripheral devices to the vendor specific other remote desktops via the communication network and a corresponding application programming interface.

5. The method according to claim 1, wherein, within the multi-cloud, multi-desktop environment, the remote terminal is running on a private cloud and each of the one or more other remote desktops is running on corresponding public cloud.

6. The method according to claim 1, wherein, within the multi-cloud, multi-desktop environment, the remote terminal is running on a public cloud and each of the one or more other remote desktops is running on corresponding private cloud.

7. The method according to claim 1, wherein in controlling the peripheral device, the method further comprising:
transmitting, by the remote driver executed by the one or more processors, each command to a message queue manager running on the remote terminal;
managing, by the message queue manager executed by the one or more processors, command execution priority for the queue based on pre-defined command sets;
transmitting, by the message queue manager executed by the one or more processors, the pre-defined command sets to a task manager running on the remote terminal; and
executing, by the task manager executed by the one or more processors, a task corresponding to controlling the peripheral device and transmitting a result of execution back to the massage queue manager.

8. A system for controlling a peripheral device among a plurality of peripheral devices in a multi-cloud, multi-desktop environment, the system comprising:
a processor; and
a memory operatively connected to the processor via a communication network, the memory storing computer readable instructions, when executed, cause the processor to:
establish a communication link among a remote terminal running on a remote desktop of a user and one or more remote desktop applications corresponding to the plurality of peripheral devices running on vendor specific other remote desktops via the communication network thereby creating a multi-cloud, multi-desktop environment;
create a synchronization agent via a corresponding application programming interface for each of said vendor specific other remote desktops, wherein the synchronization agent is configured to run on a corresponding terminal of the vendor specific other remote desktops and act as a coordinator for managing the one or more remote desktop applications running on different virtual desktop interface sessions that use different protocol specific to the corresponding vendor specific other remote desktops;
receive, by utilizing the synchronization agent executed by the processor, commands from said one or more remote desktop applications to control a peripheral device running on each virtual desktop interface session;
transmit, by utilizing the synchronization agent executed by the processor, each command to a remote driver running on the remote terminal via a corresponding vendor specific virtual channel in an order in which each command is received;
generate a queue for executing each command based on determining, by utilizing the synchronization agent executed by the processor, which remote desktop among the vendor specific other remote desktops the user is currently active on, and which command should take precedence based on a type of the peripheral device; and
control, by utilizing the synchronization agent executed by the processor, the peripheral device by executing the queue based on the type of the peripheral device within the multi-cloud, multi-desktop environment.

9. The system according to claim 8, wherein said one or more peripheral devices are physically connected to the remote terminal, and the processor is further configured to:
create, by utilizing the synchronization agent executed by the processor, one or more virtual peripheral devices that point to corresponding same one or more peripheral devices physically connected to the remote terminal; and
assign, by the synchronization agent executed by the one or more processors, the one or more virtual peripheral devices individually to the vendor specific other remote desktops in a manner such that the user sees the one or more virtual peripheral devices on each remote desktop session as individual device assigned to that specific desktop among the vendor specific other remote desktops.

10. The system according to claim 9, wherein the one or more peripheral devices include one or more of the following peripheral devices: a printer, a camera, a microphone, a monitor, a speaker, and a wireless network connection port.

11. The system according to claim 10, wherein the processor is further configured to:
virtually connect the one or more virtual peripheral devices to the vendor specific other remote desktops via the communication network and a corresponding application programming interface.

12. The system according to claim 8, wherein, within the multi-cloud, multi-desktop environment, the remote terminal is running on a private cloud and each of the one or more other remote desktops is running on corresponding public cloud.

13. The system according to claim 8, wherein, within the multi-cloud, multi-desktop environment, the remote terminal is running on a public cloud and each of the one or more other remote desktops is running on corresponding private cloud.

14. The system according to claim 1, wherein in controlling the peripheral device, the processor is further configured to:
transmit, by utilizing the remote driver executed by the processor, each command to a message queue manager running on the remote terminal;
manage, by utilizing the message queue manager executed by the processor, command execution priority for the queue based on pre-defined command sets;
transmit, by utilizing the message queue manager executed by the processor, the pre-defined command sets to a task manager running on the remote terminal; and
execute, by utilizing the task manager executed by the processor, a task corresponding to controlling the peripheral device and transmitting a result of execution back to the massage queue manager.

15. A non-transitory computer readable medium configured to store instructions for controlling a peripheral device among a plurality of peripheral devices in a multi-cloud, multi-desktop environment, the instructions, when executed, cause a processor to perform the following:
establishing a communication link among a remote terminal running on a remote desktop of a user and one or more remote desktop applications corresponding to the plurality of peripheral devices running on vendor specific other remote desktops via a communication network thereby creating a multi-cloud, multi-desktop environment;
creating a synchronization agent via a corresponding application programming interface for each of said vendor specific other remote desktops, wherein the synchronization agent is configured to run on a corresponding terminal of the vendor specific other remote desktops and act as a coordinator for managing the one or more remote desktop applications running on different virtual desktop interface sessions that use different protocol specific to the corresponding vendor specific other remote desktops;
receiving, by the synchronization agent executed by the processor, commands from said one or more remote desktop applications to control a peripheral device running on each virtual desktop interface session;
transmitting, by the synchronization agent executed by the processor, each command to a remote driver running on the remote terminal via a corresponding vendor specific virtual channel in an order in which each command is received;
generating a queue for executing each command based on determining, by the synchronization agent executed by the processor, which remote desktop among the vendor specific other remote desktops the user is currently active on, and which command should take precedence based on a type of the peripheral device; and
controlling, by the synchronization agent executed by the processor, the peripheral device by executing the queue based on the type of the peripheral device within the multi-cloud, multi-desktop environment.

16. The non-transitory computer readable medium according to claim 15, wherein said one or more peripheral devices are physically connected to the remote terminal, and the instructions, when executed, cause the processor to further perform the following:
creating, by the synchronization agent executed by the processor, one or more virtual peripheral devices that point to corresponding same one or more peripheral devices physically connected to the remote terminal; and
assigning, by the synchronization agent executed by the processor, the one or more virtual peripheral devices individually to the vendor specific other remote desktops in a manner such that the user sees the one or more virtual peripheral devices on each remote desktop session as individual device assigned to that specific desktop among the vendor specific other remote desktops.

17. The non-transitory computer readable medium according to claim 16, wherein the one or more peripheral devices include one or more of the following peripheral devices: a printer, a camera, a microphone, a monitor, a speaker, and a wireless network connection port.

18. The non-transitory computer readable medium according to claim 17, wherein the instructions, when executed, cause the processor to further perform the following:
virtually connecting the one or more virtual peripheral devices to the vendor specific other remote desktops via the communication network and a corresponding application programming interface, and
wherein, within the multi-cloud, multi-desktop environment, the remote terminal is running on a private cloud and each of the one or more other remote desktops is running on corresponding public cloud.

19. The non-transitory computer readable medium according to claim 15, wherein, within the multi-cloud, multi-desktop environment, the remote terminal is running on a public cloud and each of the one or more other remote desktops is running on corresponding private cloud.

20. The non-transitory computer readable medium according to claim 1, wherein in controlling the peripheral device, the instructions, when executed, cause the processor to further perform the following:
transmitting, by the remote driver executed by the processor, each command to a message queue manager running on the remote terminal;
managing, by the message queue manager executed by the processor, command execution priority for the queue based on pre-defined command sets;
transmitting, by the message queue manager executed by the processor, the pre-defined command sets to a task manager running on the remote terminal; and
executing, by the task manager executed by the processor, a task corresponding to controlling the peripheral device and transmitting a result of execution back to the massage queue manager.
